(19) United States
(12) Patent Application Publication
(10) Pub. No.: US 2008/0203752 A1
(43) Pub. Date: Aug. 28, 2008

(54) Tailgate Cover

(76) Inventor: Kendall B. Warkentin, St.Mary's (CA)

Correspondence Address: ADE & COMPANY INC., 2157 Henderson Highway, WINNIPEG, MB, R2G1P9, CA

(21) Appl. No.: 12/020,806

(22) Filed: Jan. 28, 2008

(30) Foreign Application Priority Data
Feb. 23, 2007 (CA) 2583003

(51) Int. Cl. B62D 33/03

(52) U.S. Cl. 296/57.1

(57) ABSTRACT

A cover for a truck tailgate has a top panel for spanning the top edge of the tailgate, an inner panel joined with the top panel for spanning the inner side of the tailgate, an outer panel joined with the top panel for spanning the outer side of the tailgate, a bottom panel joined with the outer panel for spanning the bottom edge of the tailgate, and an overlap panel joined with the bottom panel for connection with the bottom of the inner panel. Mating hook and loop fasteners are arranged to connect the interior of the inner panel to the exterior of the overlap panel such that the overlap panel is overlapped by the inner panel. End panels join the inner and outer panels at opposing ends of the top panel so as to form a pocket that receives the top edge of the tailgate therein.

This application claims foreign priority benefits from Canadian Patent Application 2,583,003 filed Feb. 23, 2007.

### FIELD OF THE INVENTION

The present invention relates to a tailgate cover arranged to cover the tailgate of truck, and more particularly relates to a cover arranged to be wrapped about the tailgate for covering both inner and outer sides of the tailgate.

### BACKGROUND

A common type of vehicle is a truck having a passenger area at front of the truck and a cargo box at the rear of the truck. The cargo box typically includes a bed surrounded by side walls and a tailgate hinged at the rear for movement between an open position lying generally horizontal in line with the bed of the cargo box and a closed position in which the gate is generally upright for surrounding the bed with the side walls. Because of the popularity of trucks as passenger vehicles, it is desirable to protect the surfaces of the truck and maintain a good finished appearance on the truck. Bed liners and tailgate covers are both known for protecting the bed of the cargo box and the tailgate respectively. The tailgate in particular has both inner and outer surfaces to be protected as both surfaces are exposed to handling of goods when loading or unloading the cargo or when performing actions near the hitch area at the rear of the truck.

Some examples of prior art attempts to protect a tailgate are listed in the following documents: U.S. Pat. No. 4,968,084 belonging to Asher et al.; U.S. Pat. No. 4,707,016 belonging to McDonald; U.S. Pat. No. 6,247,742 belonging to Boudreaux; U.S. Pat. No. 5,000,503 belonging to Bernatek; U.S. Design 433,661 belonging to Hanson and U.S. Design 323,639 belonging to Creamer.

In many of the prior art patents, the structure of the tailgate cover or the mounting configuration thereof is awkward to install and generally does not permit fully covering both the inner and outer surfaces of the gate.

U.S. Pat. No. 6,286,885 belonging to Ramos and U.S. Pat. No. 5,636,883 belonging to Johns in particular disclose covers which do extend across both inner and outer surfaces of the gate, however both are joined to the gate or to one another adjacent the bottom of the gate where a considerable gap is provided between the inner and outer panels such that dirt and debris running off of the bed of the truck box is readily accessed in between the cover and the tailgate so as to become trapped beneath the cover and cause damage to the finish of the tailgate.

### SUMMARY OF THE INVENTION

According to one aspect of the invention there is provided a tailgate cover arranged for covering a tailgate of a truck in which the tailgate has an inner side and an outer side, each spanning between a top edge and a bottom edge of the tailgate, the cover comprising:

a top panel arranged to span the top edge of the tailgate;

an inner panel and an outer panel joined along opposing sides of the top panel respectively;

the inner panel being arranged to span along the inner side of the tailgate from the top panel to a bottom end of the inner panel;

the outer panel being arranged to span along the outer side of the tailgate from the top panel to a bottom end of the outer panel; and

a fastening mechanism arranged to join the bottom ends of the inner panel and the outer panel in an overlapping configuration.

Providing panels on a tailgate cover which are arranged to be joined in an overlapping configuration ensures that the cover fully surrounds the tailgate around both the top and bottom edges thereof to prevent any access of dirt or debris between the cover and the tailgate. Furthermore the overlapping configuration is easily attached and well secured along the full width of the tailgate.

There may be provided a pair of end panels joined between the inner panel and the outer panel at opposing ends of the top panel so as to form a pocket with the inner panel, the outer panel and the top panel which is arranged to receive the top edge of the tailgate therein

According to a second aspect of the present invention there is provided a tailgate cover arranged for covering a tailgate of a truck in which the tailgate has an inner side and an outer side, each spanning between a top edge and a bottom edge of the tailgate, the cover comprising:

a top panel arranged to span the top edge of the tailgate;

an inner panel and an outer panel joined along opposing sides of the top panel respectively;

the inner panel being arranged to span along the inner side of the tailgate from the top panel to a bottom end of the inner panel;

the outer panel being arranged to span along the outer side of the tailgate from the top panel to a bottom end of the outer panel;

a pair of end panels joined between the inner panel and the outer panel at opposing ends of the top panel so as to form a pocket with the inner panel, the outer panel and the top panel which is arranged to receive the top edge of the tailgate therein; and

a fastening mechanism arranged to join the bottom ends of the inner panel and the outer panel.

When providing a pocket at the top of the tailgate, the cover is more easily aligned with the tailgate and is mounted more securely in place while ensuring that the corners of the gate are well protected both along the top edge and at the ends of the gate.

The end panels may be formed of a plurality of segments each joined integrally with the top panel at an inner end and narrowing in dimension towards an opposing outer end and in which the segments are joined to adjacent segments such that the end panels are arranged to overlap opposing ends of the tailgate.

The bottom ends of the inner and outer panel are preferably arranged to be joined in an overlapping configuration along a full width of the panels between opposing ends.

The fastening mechanism preferably comprises mating hook and loop fasteners.

The fastening mechanism may further comprise a bottom panel joined with the bottom end of the outer panel which is arranged to extend across the bottom edge of the tailgate and an overlap panel joined with the bottom panel opposite the outer panel which is arranged to be joined directly to the inner panel in an overlapping configuration.

The overlap panel is preferably arranged to be overlapped by the inner panel. When the fastening mechanism comprises mating hook and loop fasteners, the fasteners in this instance are preferably located on an interior of the inner panel and on an exterior of the overlap panel respectively.

The bottom panel is preferably narrower between opposed ends of the cover than both the outer panel and the overlap panel.

According to another aspect of the present invention, the tailgate cover may be provided in combination with the truck tailgate.

A pair of wrap panels may be arranged to be wrapped about respective opposing ends of the tailgate between the inner panel and the outer panel in which each wrap panel is integrally formed with the outer panel and arranged to be selectively fastened to the inner panel.

According to a further aspect of the present invention there is provided a tailgate cover arranged for covering a tailgate of a truck in which the tailgate has an inner side and an outer side, each spanning between a top edge and a bottom edge of the tailgate, the cover comprising:

a top panel arranged to span the top edge of the tailgate;

an inner panel and an outer panel joined along opposing sides of the top panel respectively;

the inner panel being arranged to span along the inner side of the tailgate from the top panel to a bottom end of the inner panel;

the outer panel being arranged to span along the outer side of the tailgate from the top panel to a bottom end of the outer panel;

a pair of end panels joined between the inner panel and the outer panel at opposing ends of the top panel so as to form a pocket with the inner panel, the outer panel and the top panel which is arranged to receive the top edge of the tailgate therein;

a bottom panel joined with the bottom end of the outer panel which is arranged to extend across the bottom edge of the tailgate;

an overlap panel joined with the bottom panel opposite the outer panel which is arranged to be joined directly to the inner panel;

the bottom panel being narrower between opposed ends of the cover than the outer panel and the overlap panel; and

mating hook and loop fasteners located on an interior side of the inner panel and on an exterior side of the overlap panel so as to be arranged to join the inner panel and the overlap panel in which the interior of the inner panel overlaps the exterior of the overlap panel along a full width of the panels between opposing ends of the cover.

One embodiment of the invention will now be described in conjunction with the accompanying drawings in which:

### BRIEF DESCRIPTION OF THE DRAWINGS

FIG. 1 is a perspective view of the tailgate cover supported on a tailgate in the open position.

FIG. 2 is a perspective view of the tailgate cover shown removed from a tailgate.

FIG. 3 is a rear elevational view of the cover shown supported on a tailgate.

FIG. 4 is an end elevational view of the cover shown supported on a tailgate.

FIG. 5 is a plan view of a blank which is assembled into the tailgate cover.

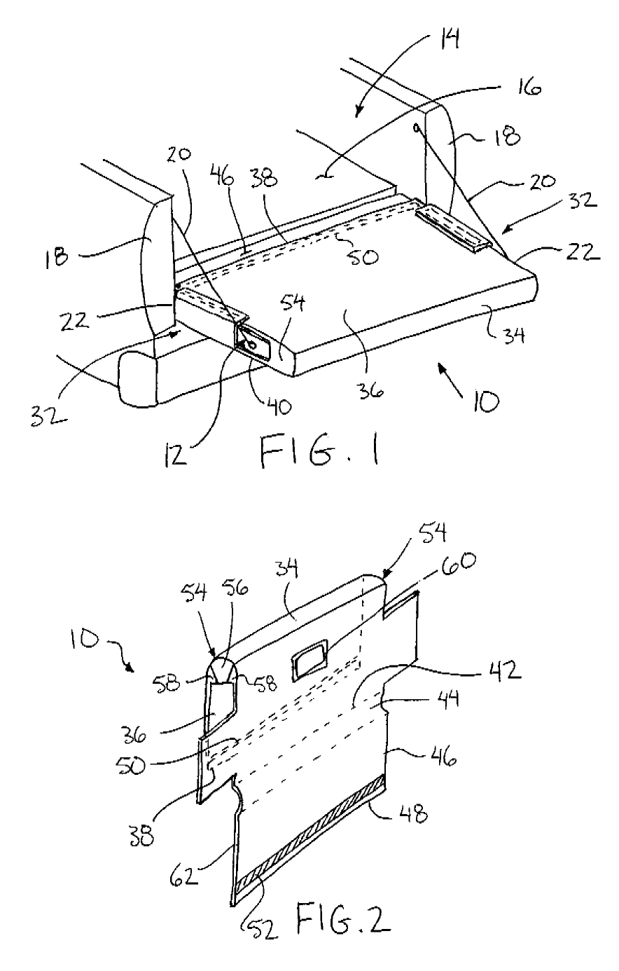

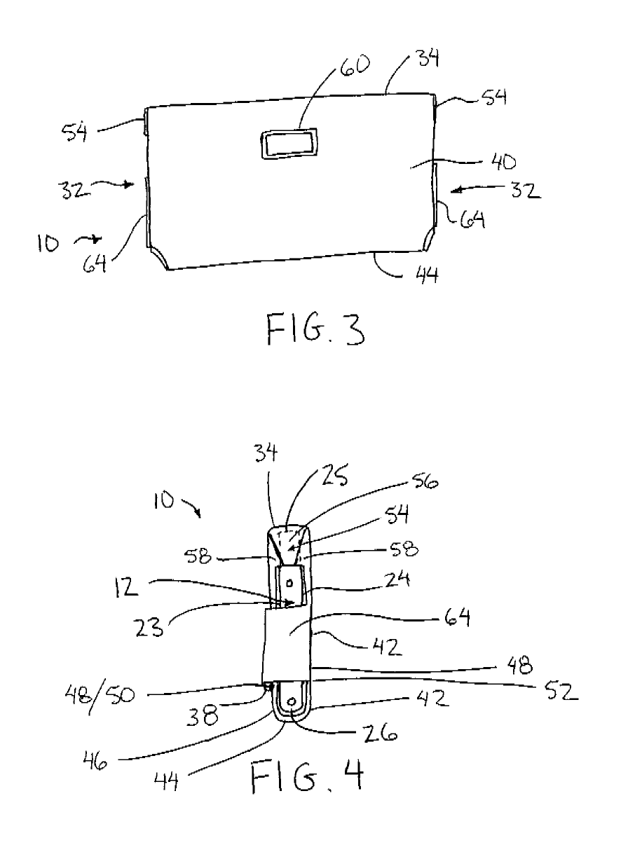

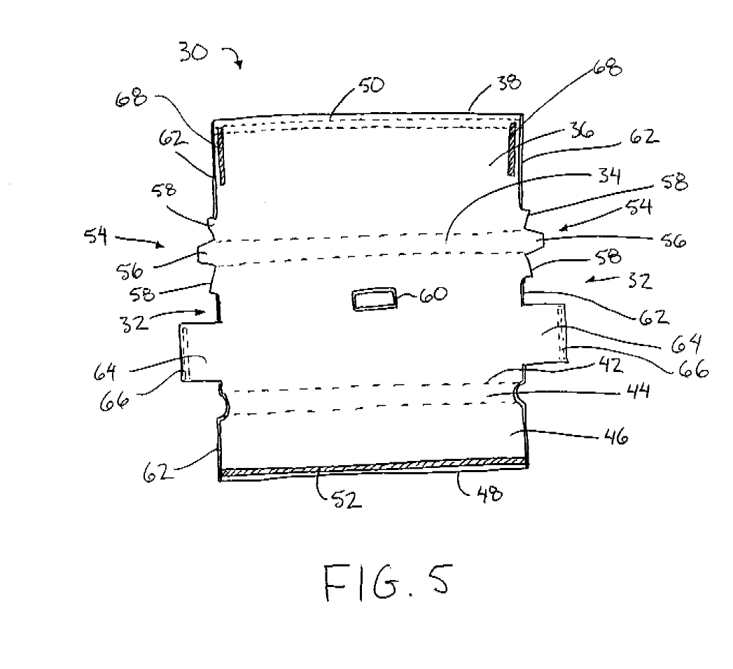

In the drawings like characters of reference indicate corresponding parts in the different figures.

### DETAILED DESCRIPTION

Referring to the accompanying figures there is illustrated a tailgate cover generally indicated by reference numeral 10. The cover 10 is particularly suited for covering the tailgate 12 of the type conventionally found on a truck having a truck box 14.

The truck box of the truck, for which the cover 10 is suited, includes a bed 16 and side walls 18 with which the tailgate is operatively connected. A suitable linkage or tether 20 couples between each of the two opposed ends 22 of the tailgate for connection to respective side walls 18 of the box to support the tailgate when the tailgate is opened into the generally horizontal position shown in FIG. 1. The tailgate includes an inner side 23 and an outer side 24 each of which spans horizontally between the opposed ends 22 and vertically between the respective top edge 25 and bottom edge 26 of the gate. The cover 10 is arranged for covering the inner and outer sides and the top and bottom edges of the gate.

The cover 10 is suitably arranged to fit each individual make and model of the truck. The cover is assembled from a blank 30 comprising a sheet of flexible material which is durable and wear resistant on an exterior side, for example vinyl or other material having like properties, while having an inner side which is softer than the exterior side for abutment against the surfaces of the tailgate. The blank 30 comprises a plurality of panels which are formed integrally with one another as a common sheet arranged to be wrapped about the tailgate while having ends 32 with openings at the opposing ends 22 of the gate for access of the tailgate hinge and tether 20 or like linkage.

The cover more particularly includes a top panel 34 which is elongate and arranged to span the top edge of the tailgate between the opposed ends 32 of the cover.

An inner panel 36 is joined integrally with the top panel 34 along one longitudinal side of the top panel. The inner panel is arranged to span the inner side of the tailgate from the top panel to a bottom end 38 of the inner panel which comprises a free end terminating before reaching the bottom edge of the gate such that the inner panel 36 is shorter in height than the gate.

An outer panel 40 is also provided which is joined integrally with the top panel 34 along an opposing longitudinally extending side of the top panel in relation to the inner panel 36. The outer panel 40 is arranged to span the outer side of the tailgate a full height of the gate from the top edge to a bottom end 42 of the outer panel. The top panel 34, the inner panel 36 and the outer panel 40 are equal in width between the opposed ends of the cover for spanning the full width of the tailgate.

The cover further includes a bottom panel 44 which is joined integrally with the bottom end 42 of the outer panel 40. The bottom panel 44 is arranged to span the bottom edge of the tailgate and is accordingly elongate between the opposing ends of the cover. The bottom panel 44 is narrower in width in between the opposed ends 32 of the cover than the outer panel 40 so as to not interfere with the hinge of the tailgate.

An overlap panel 46 is further provided on the cover which is joined integrally with the bottom panel 44 along an opposing longitudinally extending side edge relative to the outer panel 40. The overlap panel 46 has a width between the open ends 32 of the cover which is the same as the outer panel 40 so that the panel 44 is narrower than both the outer panel and the overlap panel on opposing sides thereof.

The overlap panel 46 has a height from the bottom panel 44 to a free end 48 thereof which is near, but preferably somewhat greater than the difference in height between the tailgate and the inner panel 36 so that when the overlap panel 46 is overlapped by the inner panel 36 at the respective free ends thereof, the overlap panel and the inner panel together can combine to fully span the full height of the inner side of the tailgate along the full width of the tailgate between the opposed ends thereof.

Hook and loop fasteners are provided in the form of a continuous strip of first fasteners 50 on the interior surface of the inner panel 36 along the free end thereof across the full width of the panel and as a mating continuous strip of second fasteners 52 along the exterior surface of the overlap panel 46 at the free end thereof across the full width of the panel between the opposed ends. The hook and loop fasteners, the bottom panel 44 and the overlap panel 46 operate together as a fastening mechanism for joining the bottom of the inner panel to the bottom of the outer panel in an overlapping configuration which fully surrounds the tailgate and fully covers both the inner and outer surfaces as well as the top and bottom edges of the tailgate.

The cover further comprises a pair of end panels 54 which span between the inner and outer panels at the opposed ends 32 of the cover respectively adjacent opposed ends of the top panel 34. Each end panel 54 is arranged to span the respective end surface of the tailgate only partway from the top edge towards the bottom edge, up to the tether 20 or other suitably linkage connection.

Each end panel 54 is formed of a plurality of segments comprising one central segment 56 and two side segments 58. The central segment 56 is integrally formed with the top panel 34 and has a base which is the width of the top panel. The central segment 56 of each end panel extends outwardly to a free end which is narrower in width then the base integrally joined with the top panel.

The two side segments 58 of each end panel are formed integrally with the inner and outer panels respectively at the bases thereof. The base of each side segment is approximately equal to the length of the central segment 56 between its base and free end. The side segments 58 also become narrower towards respective free ends thereof.

When the inner and outer panels are folded to be parallel and spaced apart from one another by the top panel, for receiving a tailgate therebetween, the edges of the segments forming the end panels can be joined with one another by suitable stitching or other fastening so that the segments joined together to form a continuous end panel.

A pocket is accordingly formed which is bound by the inner and outer panels and the two end panels 54 with the top panel forming the deepest part of the pocket. The pocket is suitably arranged to receive the top edge of the tailgate therein while fully surrounding the top end of the tailgate. The cover is specifically fitted to a particular make and model of truck so that the pocket snugly receives that tailgate therein. The components of the fastening mechanism, including the bottom panel 44, the overlap panel 46 and the hook and loop fasteners 50 and 52 ensure that the tailgate remains snugly received within the pocket when the fastening mechanism is secured around the opposing bottom edge of the tailgate.

A latch opening 60 is formed in the outer panel 40 so as to be centered between the opposing ends of the cover. In many instances, the latch opening 60 is nearer to the top panel than the bottom panel, but in all instances is generally located for proper alignment with the latch on the tailgate. The latch opening 60 thus provides access to the latch on the tailgate. A reinforced edging material 62 is provided along the edges of all of the panels at the opposing ends of the cover and surrounding the latch opening 60 to provide a proper finished edge and strength to the edges of the sheeted material forming the cover.

The blank 30 also includes a pair of wrap panels 64 which are integrally formed with the outer panel 40 at the opposing ends 32 of the cover. The wrap panels 64 are arranged for wrapping about the opposing ends of the tailgate at a location spaced from the end panels 54 to define an opening between the wrap panels 64 and the end panels 54 at each end 32 of the cover which is suitable for receiving the tether 20 coupling the tailgate to the side walls of the truck box. The wrap panels are also spaced upward slightly from the bottom panel so as not to interfere with the hinge of the tailgate.

A fastening mechanism is provided for securing the free outer ends of the wrap panels 64 to the exterior surface of the inner panel in the assembled position on the tailgate. The fastening mechanism generally comprises mating hook and loop fasteners 66 and 68 which are mounted respectively as a continuous strip along the interior surface of the free outer ends of the wrap panels 64 and along the exterior surface of opposing ends of the inner panel 36. The wrap panels thus overlap over the exterior surface of the inner panel at opposing ends 32 thereof in the assembled position when the hook and loop fasteners 66 and 68 are mated.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A tailgate cover arranged for covering a tailgate of a truck in which the tailgate has an inner side and an outer side, each spanning between a top edge and a bottom edge of the tailgate, the cover comprising:
a top panel arranged to span the top edge of the tailgate;
an inner panel and an outer panel joined along opposing sides of the top panel respectively;
the inner panel being arranged to span along the inner side of the tailgate from the top panel to a bottom end of the inner panel;
the outer panel being arranged to span along the outer side of the tailgate from the top panel to a bottom end of the outer panel; and
a fastening mechanism arranged to join the bottom ends of the inner panel and the outer panel in an overlapping configuration.

2. The cover according to claim 1 wherein the bottom ends of the inner and outer panel are arranged to be joined in an overlapping configuration along a full width of the panels between opposing ends.

3. The cover according to claim 1 wherein the fastening mechanism comprises mating hook and loop fasteners.

4. The cover according to claim 1 wherein the fastening mechanism comprises a bottom panel joined with the bottom end of the outer panel which is arranged to extend across the bottom edge of the tailgate and an overlap panel joined with the bottom panel opposite the outer panel which is arranged to be joined directly to the inner panel in an overlapping configuration.

5. The cover according to claim 4 wherein the overlap panel is arranged to be overlapped by the inner panel.

6. The cover according to claim 5 wherein the fastening mechanism further comprises mating hook and loop fasteners located on an interior of the inner panel and on an exterior of the overlap panel respectively.

7. The cover according to claim 4 wherein the bottom panel is narrower between opposed ends of the cover than the outer panel and the overlap panel.

8. The cover according to claim 1 wherein there is provided a pair of end panels joined between the inner panel and the outer panel at opposing ends of the top panel so as to form a pocket with the inner panel, the outer panel and the top panel which is arranged to receive the top edge of the tailgate therein

9. The cover according to claim 8 wherein the end panels are formed of a plurality of segments each joined integrally with one of the inner panel, the outer panel, or the top panel at an inner end and narrowing in dimension towards an opposing outer end, the segments being joined to adjacent ones of the segments such that the end panels are arranged to overlap opposing ends of the tailgate.

10. The cover according to claim 1 wherein there is provided a pair of wrap panels arranged to be wrapped about respective opposing ends of the tailgate between the inner panel and the outer panel, each wrap panel being integrally formed with the outer panel and arranged to be selectively fastened to the inner panel.

11. A tailgate cover arranged for covering a tailgate of a truck in which the tailgate has an inner side and an outer side, each spanning between a top edge and a bottom edge of the tailgate, the cover comprising:
a top panel arranged to span the top edge of the tailgate;
an inner panel and an outer panel joined along opposing sides of the top panel respectively;
the inner panel being arranged to span along the inner side of the tailgate from the top panel to a bottom end of the inner panel;
the outer panel being arranged to span along the outer side of the tailgate from the top panel to a bottom end of the outer panel;
a pair of end panels joined between the inner panel and the outer panel at opposing ends of the top panel so as to form a pocket with the inner panel, the outer panel and the top panel which is arranged to receive the top edge of the tailgate therein; and
a fastening mechanism arranged to join the bottom ends of the inner panel and the outer panel.

12. The cover according to claim 11 wherein the end panels are formed of a plurality of segments each joined integrally with one of the inner panel, the outer panel, or the top panel at an inner end and narrowing in dimension towards an opposing outer end, the segments being joined to adjacent ones of the segments such that the end panels are arranged to overlap opposing ends of the tailgate.

13. The cover according to claim 11 wherein the bottom ends of the inner and outer panel are arranged to be joined in an overlapping configuration along a full width of the panels between opposing ends.

14. The cover according to claim 11 wherein the fastening mechanism comprises mating hook and loop fasteners.

15. The cover according to claim 11 wherein the fastening mechanism comprises a bottom panel joined with the bottom end of the outer panel which is arranged to extend across the bottom edge of the tailgate and an overlap panel joined with the bottom panel opposite the outer panel which is arranged to be joined directly to the inner panel in an overlapping configuration.

16. The cover according to claim 15 wherein the overlap panel is arranged to be overlapped by the inner panel.

17. The cover according to claim 16 wherein the fastening mechanism further comprises mating hook and loop fasteners located on an interior of the inner panel and on an exterior of the overlap panel respectively.

18. The cover according to claim 15 wherein the bottom panel is narrower between opposed ends of the cover than the outer panel and the overlap panel.

19. The cover according to claim 11 wherein there is provided a pair of wrap panels arranged to be wrapped about respective opposing ends of the tailgate between the inner panel and the outer panel, each wrap panel being integrally formed with the outer panel and arranged to be selectively fastened to the inner panel.

20. A tailgate cover arranged for covering a tailgate of a truck in which the tailgate has an inner side and an outer side, each spanning between a top edge and a bottom edge of the tailgate, the cover comprising:
a top panel arranged to span the top edge of the tailgate;
an inner panel and an outer panel joined along opposing sides of the top panel respectively;
the inner panel being arranged to span along the inner side of the tailgate from the top panel to a bottom end of the inner panel;
the outer panel being arranged to span along the outer side of the tailgate from the top panel to a bottom end of the outer panel;
a pair of end panels joined between the inner panel and the outer panel at opposing ends of the top panel so as to form a pocket with the inner panel, the outer panel and the top panel which is arranged to receive the top edge of the tailgate therein;
a bottom panel joined with the bottom end of the outer panel which is arranged to extend across the bottom edge of the tailgate;
an overlap panel joined with the bottom panel opposite the outer panel which is arranged to be joined directly to the inner panel;
the bottom panel being narrower between opposed ends of the cover than the outer panel and the overlap panel; and
mating hook and loop fasteners located on an interior side of the inner panel and on an exterior side of the overlap panel so as to be arranged to join the inner panel and the overlap panel in which the interior of the inner panel overlaps the exterior of the overlap panel along a full width of the panels between opposing ends of the cover.
